(19) United States
(12) Patent Application Publication
(10) Pub. No.: US 2021/0225571 A1
(43) Pub. Date: Jul. 22, 2021

(54) LAMINATED CORE

(71) Applicant: TOYOTA JIDOSHA KABUSHIKI KAISHA, Toyota-shi (JP)

(72) Inventors: Shigeru Konda, Kariya-shi (JP); Yukihiro Yoshida, Akita-shi (JP)

(73) Assignee: TOYOTA JIDOSHA KABUSHIKI KAISHA, Toyota-shi (JP)

(21) Appl. No.: 17/140,592

(22) Filed: Jan. 4, 2021

(30) Foreign Application Priority Data
Jan. 16, 2020 (JP) 2020-005237

(51) Int. Cl. H01F 3/02; H01F 1/18; H02K 1/12

(52) U.S. Cl. CPC H01F 3/02; H02K 1/12; H01F 1/18

(57) ABSTRACT

A laminated core that enables reducing an eddy-current loss while reducing a decrease in space factor is provided. The laminated core includes a plurality of laminated soft magnetic strips and at least one insulating layer arranged in part of each interface between the soft magnetic strips adjacent to one another. Each of the interfaces between the soft magnetic strips adjacent to one another includes at least one direct contact region and at least one indirect contact region. The soft magnetic strips adjacent to one another are in direct contact with one another in the at least one direct contact region. The soft magnetic strips adjacent to one another are in indirect contact with one another via the insulating layer in the at least one indirect contact region.

### CROSS REFERENCE TO RELATED APPLICATIONS

The present application claims priority from Japanese patent application JP 2020-005237 filed on Jan. 16, 2020, the entire content of which is hereby incorporated by reference into this application.

### BACKGROUND

### Technical Field

The present disclosure relates to a laminated core.

### Background Art

To improve energy efficiency of machines such as a hybrid vehicle and an electric vehicle, a reduction in eddy-current loss of a core of a motor used for these machines is required. Therefore, to reduce the eddy-current loss, a laminated core in which a plurality of electromagnetic steel strips are laminated has been used as the core of the motor.

JP H08-162335 A discloses a core constituted by laminating steel plates having surfaces on which oxide films are formed. According to JP H08-162335 A, the oxide films increase a contact resistance between the steel plates, and this reduces an eddy current flowing through the core. JP 2012-511628 T discloses a method for manufacturing a steel strip in which an iron oxide coating is formed.

JP 2019-188751 A discloses an electromagnetic steel sheet that can be used as, for example, a motor or a transformer core material and includes a coat containing an organic material on an outermost surface of one surface and a coat containing a low-melting-point glass on at least a part of an outermost surface of the other surface.

JP 2008-036671 A discloses a method for crimping electromagnetic steel sheets used to manufacture a laminated electromagnetic steel sheet. The method described in JP 2008-036671 A avoids a breakage of an insulation film formed on an electromagnetic steel sheet surface to maintain an insulating property between the electromagnetic steel sheets and reduce an iron loss.

JP 2000-282191 A discloses a steel plate for laminated core having a surface roughness from 0.6 to 4.0 μm applied to a laminated core of an alternator and a starter motor.

### SUMMARY

To further reduce the eddy-current loss, a development of a laminated core including electromagnetic steel strips having a further small thickness has been proceeded. However, the reduction in thickness of the electromagnetic steel strip decreases a volume proportion of electromagnetic steel in the core, namely, a space factor, resulting in decrease in an output from the motor.

The present disclosure provides a laminated core that enables reducing an eddy-current loss while reducing a decrease in space factor.

According to one aspect of the present disclosure, there is provided a laminated core that comprises a plurality of laminated soft magnetic strips and at least one insulating layer. The at least one insulating layer is arranged in part of each interface between the soft magnetic strips adjacent to one another. Each of the interfaces between the soft magnetic strips adjacent to one another includes at least one direct contact region and at least one indirect contact region. The soft magnetic strips adjacent to one another are in direct contact with one another in the at least one direct contact region. The soft magnetic strips adjacent to one another are in indirect contact with one another via the insulating layer in the at least one indirect contact region.

The laminated core according to the present disclosure enables reducing an eddy-current loss while reducing a decrease in space factor.

### BRIEF DESCRIPTION OF THE DRAWINGS

FIG. 1 is a schematic perspective view of a laminated core according to a first embodiment;

FIG. 2 is a drawing schematically illustrating an example of a cross-section of the laminated core according to the first embodiment, the cross-section taken along an interface between soft magnetic strips adjacent to one another;

FIG. 3 is a drawing schematically illustrating an example of a cross-section of the laminated core according to the first embodiment, the cross-section taken along the line A-A in FIG. 2;

FIG. 4 is a drawing schematically illustrating an example of a cross-section of the laminated core according to the first embodiment, the cross-section taken along the line B-B in FIG. 2;

FIG. 5 is a drawing schematically illustrating an example of a cross-section of a laminated core according to a second embodiment, the cross-section taken along an interface between soft magnetic strips adjacent to one another;

FIG. 6 is a drawing schematically illustrating an example of a cross-section of the laminated core according to the second embodiment, the cross-section taken along the line C-C in FIG. 5:

FIG. 7 is a drawing schematically illustrating an example of a cross-section of a laminated core according to a third embodiment, the cross-section taken along an interface between soft magnetic strips adjacent to one another;

FIG. 8 is a drawing schematically illustrating an example of a cross-section of the laminated core according to the third embodiment, the cross-section taken along the line D-D in FIG. 7;

FIG. 9 is a drawing schematically illustrating an example of a cross-section of a laminated core according to a modified embodiment, the cross-section taken along an interface between soft magnetic strips adjacent to one another;

FIG. 10 is a drawing schematically illustrating an example of a cross-section of a laminated core according to a modified embodiment, the cross-section taken along an interface between soft magnetic strips adjacent to one another;

FIG. 11 is a drawing schematically illustrating an example of a cross-section of a laminated core according to a modified embodiment, the cross-section taken along an interface between soft magnetic strips adjacent to one another;

FIG. 12 is a graph showing a calculation result of eddy-current losses in a laminated core of Example 1 and a measurement result of eddy-current losses in a laminated core of Example 2;

FIG. 13 is a graph showing a measurement result of eddy-current losses in a laminated core of Example 4; and

FIG. 14 is a graph showing a measurement result of eddy-current losses in a laminated core of Example 6.

### DETAILED DESCRIPTION

### First Embodiment

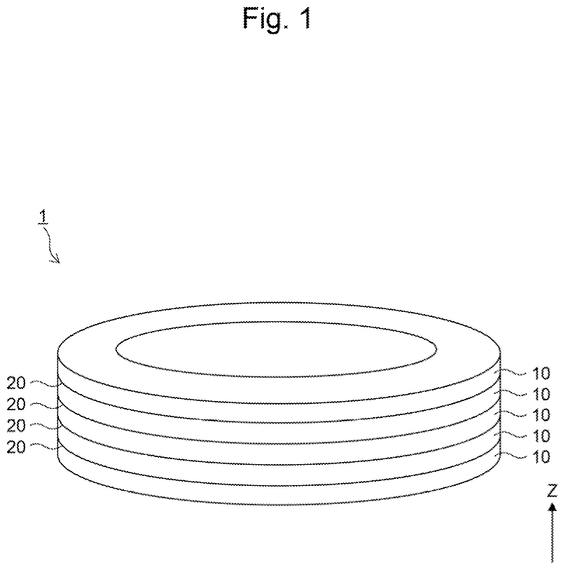

As illustrated in FIGS. 1 to 4, a laminated core 1 according to the first embodiment includes a plurality of laminated soft magnetic strips 10 and insulating layers 30 arranged in part of respective interfaces 20 between the soft magnetic strips 10 adjacent to one another.

(1) Soft Magnetic Strip

The soft magnetic strip 10 is a plate-shaped or a foil-shaped member made of a soft magnetic material. The soft magnetic strip 10 may have a thickness from several nm to 1 mm, from 1 μm to 1 mm in some embodiments, and from 10 μm to 20 μm in some embodiments. Examples of the soft magnetic material include a material containing at least one kind of a magnetic metal selected from the group consisting of Fe, Co, and Ni and at least one kind of a non-magnetic metal selected from the group consisting of B, C, P, Al, Si, Ti, V, Cr, Mn, Cu, Y, Zr, Nb, Mo, Hf, Ta, and W, but the soft magnetic material is not limited to these materials. The soft magnetic material may be amorphous or crystalline. For example, as the soft magnetic strip 10, an electromagnetic steel sheet (silicon steel plate), an amorphous alloy ribbon, and a nanocrystalline alloy ribbon can be used.

The soft magnetic strip 10 has a ring shape in plan view in the laminating direction (Z direction in FIG. 1) of the soft magnetic strips 10. While the soft magnetic strip 10 illustrated in FIG. 1 has the circular ring shape, the shape is not limited to this shape, and the soft magnetic strip 10 may have any ring shape, such as a rectangular ring shape.

The number of the soft magnetic strips 10 may be appropriately determined according to the material of the soft magnetic strip 10 and the like so as to realize a motor having a desired torque.

(2) Interface

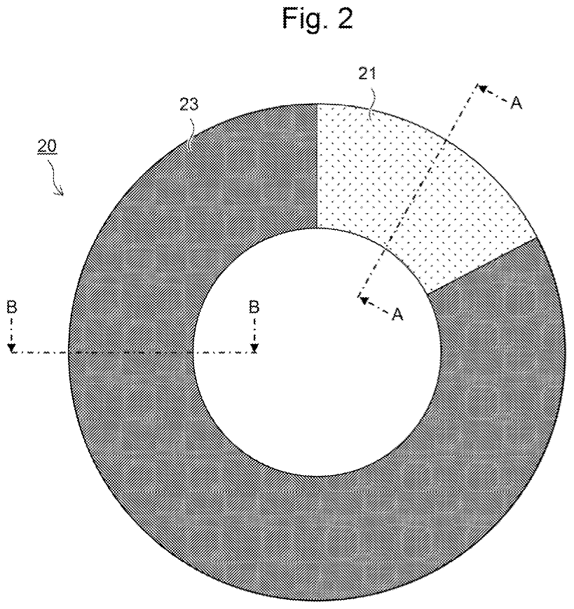

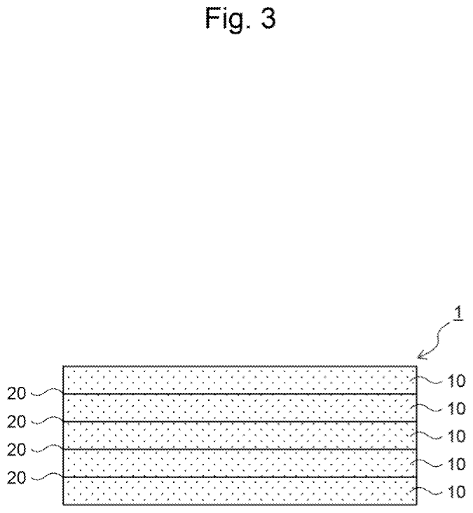

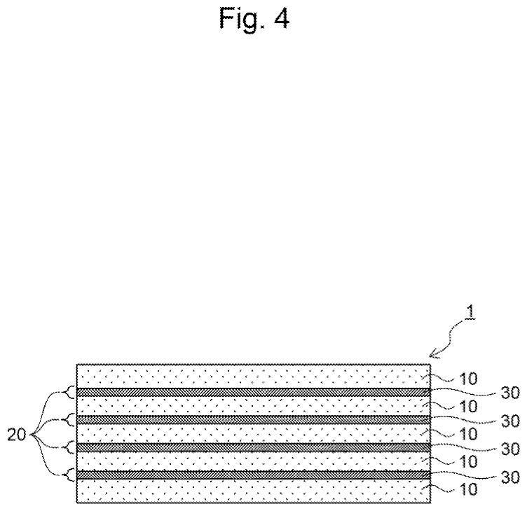

The plurality of soft magnetic strips 10 are laminated in the laminated core 1, and the interfaces 20 are formed between the soft magnetic strips 10 adjacent to one another. Note that, in this application, “the interface 20 between the soft magnetic strips 10 adjacent to one another” means a region between the soft magnetic strips 10 adjacent to one another. As illustrated in FIG. 2, the interfaces 20 in the laminated core 1 each include a direct contact region 21 and an indirect contact region 23. As illustrated in FIG. 3, the direct contact region 21 is a region where the soft magnetic strips 10 adjacent to one another are in direct contact with one another, and as illustrated in FIG. 4, the indirect contact region 23 is a region where the soft magnetic strips 10 adjacent to one another are in indirect contact with one another via the insulating layer 30.

As illustrated in FIG. 2, the interface 20 in the first embodiment includes a single direct contact region 21 and a single indirect contact region 23. The direct contact region 21 has a partial circular ring shape having an inner diameter and an outer diameter the same as an inner diameter and an outer diameter of the soft magnetic strip 10, respectively, and similarly, the indirect contact region 23 also has a partial circular ring shape having an inner diameter and an outer diameter the same as the inner diameter and the outer diameter of the soft magnetic strip 10, respectively. The shapes and arrangements of the direct contact region 21 are the same in all the interfaces 20 in the laminated core 1 in plan view in the laminating direction of the soft magnetic strips 10 and the shapes and arrangements of the indirect contact regions 23 are also the same in all the interfaces 20 in the laminated core 1.

(3) Insulating Layer

One insulating layer 30 is arranged in part of each interface 20 between the soft magnetic strips 10 adjacent to one another. Specifically, the insulating layer 30 is arranged in the indirect contact region 23 of the interface 20 between the soft magnetic strips 10 adjacent to one another. Note that, in this application, “arranged in the interface 20 between the soft magnetic strips 10 adjacent to one another” means “arranged between the soft magnetic strips 10 adjacent to one another.”

The insulating layer 30 is a layer made of an insulator. The insulating layer 30 may have an electrical resistance of 1×10⁴ to 1×10¹⁵ Ω·m and 2×10¹¹ to 1×10¹⁵ Ω·m in some embodiments. The insulating layer 30 may have a thickness 0.01 times or less of a thickness of the soft magnetic strip 10, for example, the thickness in a range from 0.001 to 0.01 times. This allows the laminated core 1 to have a high space factor exceeding 99%. For example, the insulating layer 30 may have the thickness from 0.5 nm to 17.5 μm. Examples of the insulator include an inorganic material, such as a metallic oxide, and an organic material, such as an epoxy resin, an alkyd resin, a polyimide resin, a polyamide-imide resin, and an imide-modified acrylic resin, but the insulator is not limited to these materials.

The insulating layer 30 has a shape similar to that of the indirect contact region 23, that is, a partial circular ring shape having an inner diameter and an outer diameter the same as the inner diameter and the outer diameter of the soft magnetic strip 10, respectively. The insulating layer 30 arranged in every interface 20 in the laminated core 1 has the same shape and arrangement in plan view in the laminating direction of the soft magnetic strips 10.

The laminated core 1 of the first embodiment in which the insulating layers 30 are arranged in part of the interfaces 20 between the soft magnetic strips 10 adjacent to one another has a proportion of the insulating layer 30 lower than that of the conventional laminated core in which an insulating layer is arranged in the whole interface between soft magnetic strips adjacent to one another. Therefore, the laminated core 1 of the first embodiment can have the space factor higher than that of the conventional laminated core.

In the first embodiment, a flow of an eddy current from one soft magnetic strip 10 to the adjacent soft magnetic strip 10 is avoided in the indirect contact region 23 since the soft magnetic strips 10 are in indirect contact with one another via the insulating layer 30. On the other hand, in the direct contact region 21, the insulating layer 30 is absent and the soft magnetic strips 10 are in direct contact with one another, and therefore the eddy current possibly flows from one soft magnetic strip 10 to the adjacent soft magnetic strip 10. However, as will be described in examples described later, the inventors have found that appropriately designing areas and arrangements of the direct contact region 21 and the indirect contact region 23 allows sufficiently reducing the eddy-current loss.

In the first embodiment, the direct contact region 21 may have an area larger than 0% and 20% or less of an area of the interface 20. This allows sufficiently reducing the eddy-current loss in the motor.

### Second Embodiment

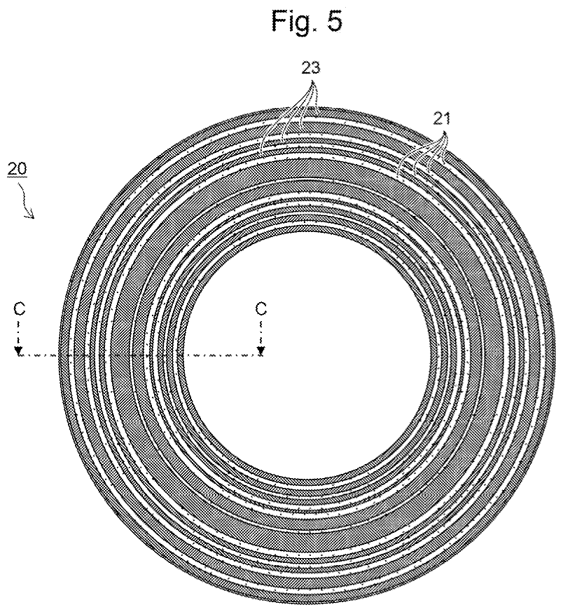

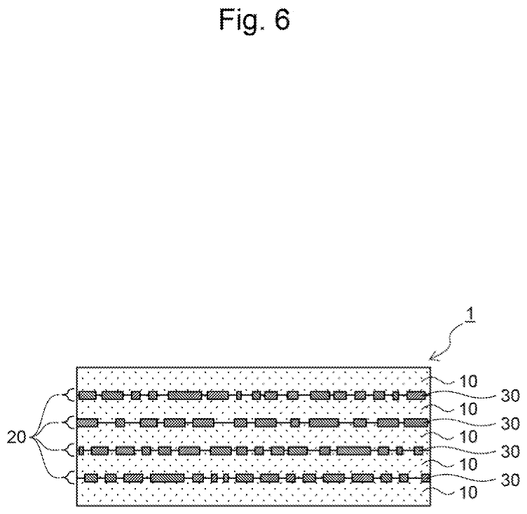

As illustrated in FIGS. 5 and 6, the laminated core 1 according to the second embodiment includes the plurality of laminated soft magnetic strips 10 and the plurality of insulating layers 30 arranged in part of each interface 20 between the soft magnetic strips 10 adjacent to one another.

(1) Soft Magnetic Strip

The soft magnetic strip 10 in the second embodiment is similar to the soft magnetic strip 10 in the first embodiment, and therefore the description is omitted.

(2) Interface

As illustrated in FIGS. 5 and 6, the interfaces 20 between the soft magnetic strips 10 adjacent to one another each include the region where the soft magnetic strips 10 adjacent to one another are in direct contact with one another, namely, the direct contact region 21, and the region where the soft magnetic strips 10 adjacent to one another are in indirect contact with one another via the insulating layers 30, namely, the indirect contact region 23.

As illustrated in FIG. 5, the interface 20 in the second embodiment includes the plurality of direct contact regions 21 and the plurality of indirect contact regions 23 having circular ring shapes concentric with the soft magnetic strip 10. As illustrated in FIG. 6, the numbers of the direct contact regions 21 and the indirect contact regions 23 in each interface 20 in the laminated core 1 and respective inner diameters and outer diameters of the plurality of direct contact regions 21 and the plurality of indirect contact regions 23 are random. In this case, in plan view in the laminating direction of the soft magnetic strips 10, every interface 20 includes the direct contact regions 21 and the indirect contact regions 23 in the arrangements different from the arrangements of the direct contact regions 21 and the indirect contact regions 23 in an interface 20 adjacent to such an interface 20 (that is, an interface 20 opposed to such an interface 20 via one soft magnetic strip 10). Especially, in plan view in the laminating direction of the soft magnetic strips 10, every interface 20 may have the direct contact regions 21 in the arrangement different from the arrangement of the direct contact regions 21 in any other interface 20, and every interface 20 may have the indirect contact regions 23 in the arrangement different from the arrangement of the indirect contact regions 23 in any other interface 20.

(3) Insulating Layer

The plurality of insulating layers 30 are arranged in part of each interface 20 between the soft magnetic strips 10 adjacent to one another. Specifically, the insulating layers 30 are arranged in the respective plurality of indirect contact regions 23.

The material and the thickness of the insulating layer 30 are similar to those of the first embodiment, and therefore the description is omitted.

The insulating layer 30 has a shape similar to that of the indirect contact region 23, that is, the circular ring shapes concentric with the soft magnetic strip 10. In plan view in the laminating direction of the soft magnetic strips 10, the insulating layers 30 disposed in every interface 20 are in the arrangement different from the arrangement of the insulating layers 30 disposed in an interface 20 adjacent to such an interface 20. Especially, in plan view in the laminating direction of the soft magnetic strips 10, the insulating layers 30 disposed in every interface 20 may be in the arrangement different from the arrangements of the insulating layers 30 disposed in any other interface 20.

The laminated core 1 of the second embodiment in which the insulating layers 30 are arranged in part of the interface 20 between the soft magnetic strips 10 adjacent to one another has a proportion of the insulating layers 30 lower than that of the conventional laminated core in which the insulating layer is arranged in the whole interface between the soft magnetic strips adjacent to one another. Therefore, the laminated core 1 of the second embodiment can have the space factor higher than that of the conventional laminated core.

In the second embodiment, the flow of the eddy current from one soft magnetic strip 10 to the other soft magnetic strip 10 adjacent to one another is avoided in the indirect contact region 23 since the soft magnetic strips 10 are in indirect contact with one another via the insulating layers 30. On the other hand, in the direct contact region 21, the insulating layer 30 is absent and the soft magnetic strips 10 are in direct contact with one another, and therefore the eddy current possibly flows from one soft magnetic strip 10 to the other soft magnetic strip 10 adjacent to one another. However, as will be described in the examples described later, the inventors have found that appropriately designing the areas and the arrangements of the direct contact regions 21 and the indirect contact regions 23 allows sufficiently reducing the eddy-current loss.

Furthermore, in the laminated core 1 of the second embodiment, the plurality of direct contact regions 21 are disposed in each interface 20, and in plan view in the laminating direction of the soft magnetic strips 10, the arrangements of the plurality of direct contact regions 21 in the interfaces 20 adjacent to one another (that is, a pair of the interfaces 20 between which one soft magnetic strip 10 is interposed) are different. As described in the examples described later, the total area of the indirect contact regions 23 (that is, the total area of the insulating layers 30) required to reduce the eddy-current loss in the laminated core 1 of the second embodiment is smaller than the total area of the indirect contact region 23 required to reduce the eddy-current loss in the laminated core 1 of the first embodiment in which a single direct contact region 21 is disposed in each interface 20 and the arrangements of the direct contact regions 21 and the indirect contact regions 23 in the interfaces 20 adjacent to one another are the same in plan view in the laminating direction of the soft magnetic strips 10. Therefore, the laminated core 1 of the second embodiment allows sufficiently reducing the eddy-current loss while further reducing the proportion of the insulating layers 30 and achieving the further high space factor.

The inventors have considered the reason for this as follows. As long as the total areas of the direct contact regions 21 in the interface 20 are the same, each direct contact region 21 in the interface 20 including the plurality of direct contact regions 21 has an area smaller than the area of the direct contact region 21 in the interface 20 including a single direct contact region 21. Therefore, when the interface 20 includes the plurality of direct contact regions 21, in plan view in the laminating direction of the soft magnetic strips 10, an area of each region where the eddy current flows is smaller than an area of each region where the eddy current flows in the interface 20 including a single direct contact region 21. This reduces the eddy current generated in the laminated core 1. Furthermore, in plan view in the laminating direction of the soft magnetic strips 10, the difference in the arrangements of the plurality of direct contact regions 21 in the interfaces 20 adjacent to one another reduces the flow of the eddy current passing through the plurality of soft magnetic strips 10 in the laminating direction of the soft magnetic strips 10. This reduces the eddy current generated in the laminated core 1.

In the second embodiment, the direct contact regions 21 may have the area larger than 0% and 60% or less of the area of the interface 20. This allows sufficiently reducing the eddy-current loss in the motor.

### Third Embodiment

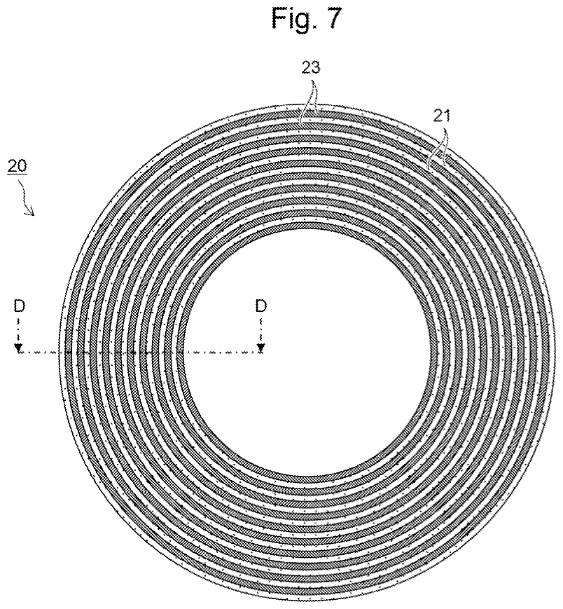

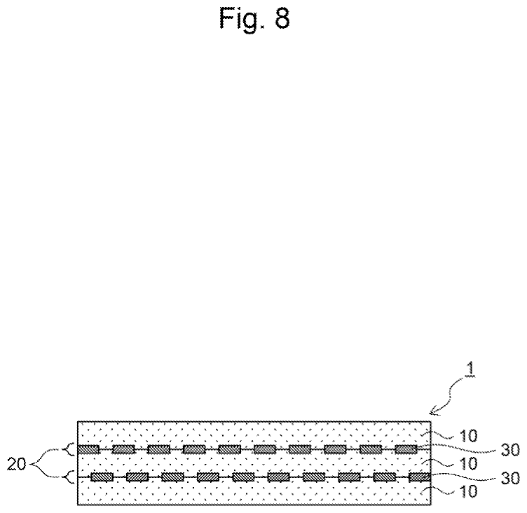

As illustrated in FIGS. 7 and 8, the laminated core 1 according to the third embodiment includes the plurality of laminated soft magnetic strips 10 and the plurality of insulating layers 30 arranged in part of each interface 20 between the soft magnetic strips 10 adjacent to one another.

(1) Soft Magnetic Strip

The soft magnetic strip 10 in the third embodiment is similar to the soft magnetic strip 10 in the first embodiment, and therefore the description is omitted.

(2) Interface

As illustrated in FIGS. 7 and 8, the interfaces 20 between the soft magnetic strips 10 adjacent to one another each include the region where the soft magnetic strips 10 adjacent to one another are in direct contact with one another, namely, the direct contact region 21, and the region where the soft magnetic strips 10 adjacent to one another are in indirect contact with one another via the insulating layers 30, namely, the indirect contact region 23.

As illustrated in FIG. 7, the interface 20 in the third embodiment includes the plurality of direct contact regions 21 and the plurality of indirect contact regions 23 having circular ring shapes concentric with the soft magnetic strip 10. The direct contact regions 21 and the indirect contact regions 23 are regularly arranged at a constant pitch. As illustrated in FIG. 8, the numbers and pitches of the direct contact regions 21 and the indirect contact regions 23 in the respective interfaces 20 in the laminated core 1 are the same.

In plan view in the laminating direction of the soft magnetic strips 10, phases of the direct contact regions 21 and the indirect contact regions 23 in the interfaces 20 adjacent to one another may be matched or may be shifted. By shifting the phases, an area of regions included in the direct contact regions 21 of one of the interfaces 20 adjacent to one another, the regions overlapping with the direct contact regions 21 of the other of the interfaces 20 adjacent to one another in plan view in the laminating direction of the soft magnetic strips 10, can be reduced. This reduces the flow of the eddy current passing through the plurality of soft magnetic strips 10 in the laminating direction of the soft magnetic strips 10 and the eddy current generated in the laminated core 1 can be reduced.

For example, the area of the regions included in the direct contact regions 21 of one of the interfaces 20 adjacent to one another, the regions overlapping with the direct contact regions 21 in the other of the interfaces 20 adjacent to one another in plan view in the laminating direction of the soft magnetic strips 10, may be from 0 to 10° % of the area of the interface 20 or may be from 0 to 25% of the total area of the direct contact regions 21 in the interface 20.

(3) Insulating Layer

The plurality of insulating layers 30 are arranged in part of each interface 20 between the soft magnetic strips 10 adjacent to one another. Specifically, the respective insulating layers 30 are arranged in the plurality of indirect contact regions 23.

The material and the thickness of the insulating layer 30 are similar to those of the first embodiment, and therefore the description is omitted.

The insulating layer 30 has a shape similar to that of the indirect contact region 23, that is, the circular ring shapes concentric with the soft magnetic strip 10. The insulating layers 30 arranged in each interface 20 in the laminated core 1 are regularly arranged at a constant pitch. As illustrated in FIG. 8, the numbers and pitches of the insulating layers 30 arranged in the respective interfaces 20 in the laminated core 1 are the same.

In plan view in the laminating direction of the soft magnetic strips 10, phases of the insulating layers 30 arranged in the interfaces 20 adjacent to one another may be matched or may be shifted to one another.

The laminated core 1 of the third embodiment in which the insulating layers 30 are arranged in part of the interface 20 between the soft magnetic strips 10 adjacent to one another has the proportion of the insulating layers 30 lower than that of the conventional laminated core in which the insulating layer is arranged in the whole interface between the soft magnetic strips adjacent to one another. Therefore, the laminated core 1 of the third embodiment can have the space factor higher than that of the conventional laminated core.

In the third embodiment, the flow of the eddy current from one soft magnetic strip 10 to the other soft magnetic strip 10 adjacent to one another is avoided in the indirect contact region 23 since the soft magnetic strips 10 are in indirect contact with one another via the insulating layers 30. On the other hand, in the direct contact region 21, the insulating layer 30 is absent and the soft magnetic strips 10 are in direct contact with one another, and therefore the eddy current possibly flows from one soft magnetic strip 10 to the other sol magnetic strip 10 adjacent to one another. However, as will be described in the examples described later, the inventors have found that appropriately designing the areas and the arrangements of the direct contact regions 21 and the indirect contact regions 23 allows sufficiently reducing the eddy-current loss.

The above-described laminated cores according to the embodiments can be used as the core of the motor embedded into various kinds of machinery, for example, a vehicle, such as a hybrid vehicle and an electric vehicle.

<Method for Manufacturing Laminated Core>

The above-described laminated cores according to the embodiments may be manufactured using any method used in the technical field. For example, the laminated core can be manufactured by manufacturing a laminated body in which a plurality of soft magnetic strips and a plurality of insulating foils are laminated in alternation and pressing the laminated body.

### Modified Embodiment

While the embodiments of the present disclosure have been described in detail above, the present disclosure is not limited thereto, and can be subjected to various kinds of changes in design without departing from the spirit of the present disclosure described in the claims.

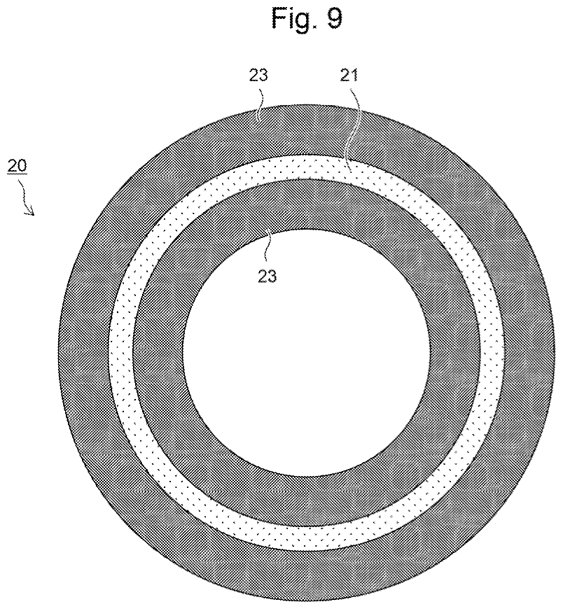

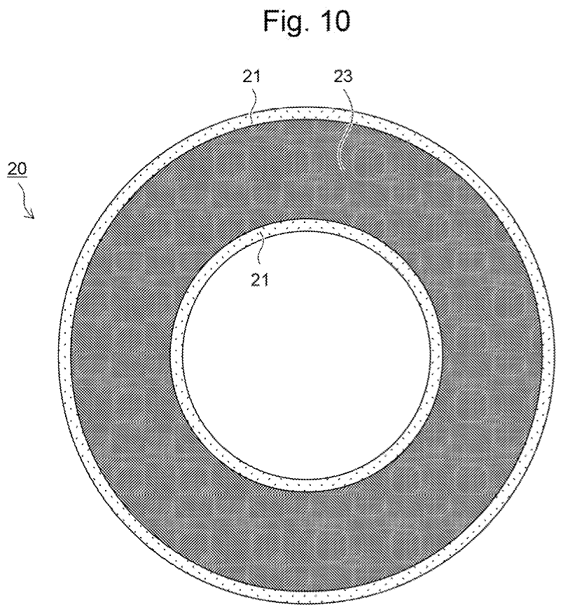

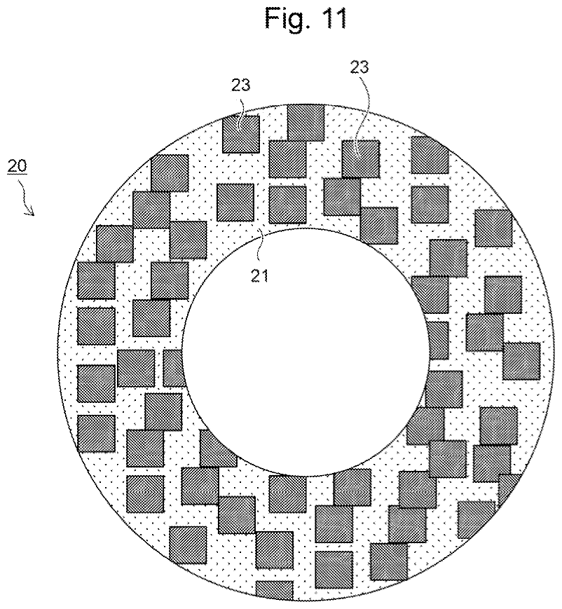

For example, the interfaces 20 may each include a single direct contact region 21 and a plurality of indirect contact regions 23. FIG. 9 illustrates an example of such an interface 20. Alternatively, the interfaces 20 may each include a plurality of direct contact regions 21 and a single indirect contact region 23. FIG. 10 illustrates an example of such an interface 20. In plan view in the laminating direction of the soft magnetic strips 10, the shapes of the direct contact region 21 and the indirect contact region 23 in each interface 20 are not limited to the partial circular ring shape or the circular ring shape but may be any shape. In plan view in the laminating direction of the soft magnetic strips 10, the arrangements of the direct contact regions 21 and the indirect contact regions 23 in the respective interfaces 20 may be periodic or irregular. For example, as illustrated in FIG. 11, the interface 20 may include the irregularly arranged indirect contact regions 23. Furthermore, when the laminated core 1 includes the plurality of interfaces 20, in plan view in the laminating direction of the soft magnetic strips 10, the plurality of interfaces 20 may include the direct contact regions 21 having the same shape and arrangement and the indirect contact regions 23 having the same shape and arrangement, or may include the direct contact regions 21 having different shapes and arrangements and the indirect contact regions 23 having different shapes and arrangements.

These features (that is, the numbers, the shapes, and the arrangements of the direct contact regions 21 and the indirect contact regions 23 in each interface 20, and whether the shapes and the arrangements of the direct contact regions 21 and the indirect contact regions 23 in the plurality of interfaces 20 are the same or different) may be given in any combination.

### EXAMPLES

The following specifically describes the present disclosure with the examples, but the present disclosure is not limited to these examples.

### Example 1

Eddy-current losses of laminated cores including five laminated soft magnetic strips having a circular ring shape and insulating layers disposed between the soft magnetic strips adjacent to one another as illustrated in FIGS. 1 to 4 were calculated using the magnetic circuit method described in Shigeru Konda et al., “Eddy current loss evaluation of magnetic powder core based on electric and magnetic networks”, AIP Advances 7, 056678 (2017).

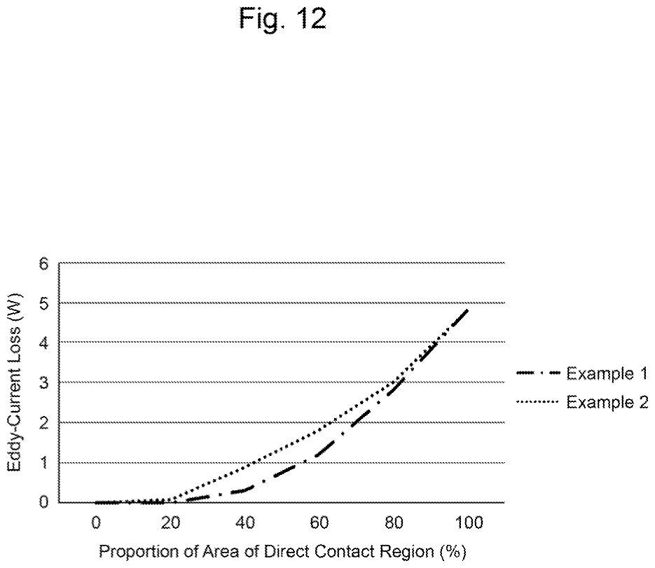

In the laminated core of Example 1, a single partial circular ring-shaped insulating layer was disposed in an interface between the soft magnetic strips adjacent to one another. Thus, a single direct contact region having a partial circular ring shape and a single indirect contact region having a partial circular ring shape were formed in each interface. The soft magnetic strips adjacent to one another were in direct contact with one another in the direct contact region, and the soft magnetic strips adjacent to one another were in indirect contact with one another via the insulating layer in the indirect contact region. An area of the direct contact region was set to be from 0 to 100% of an area of the interface. Note that shapes and arrangements of the insulating layers in plan view in the laminating direction of the soft magnetic strips were the same in all the interfaces. Values of resistivity, a thickness, a width, a length, and an outer diameter and an inner diameter of the soft magnetic strip, a resistivity and a thickness of the insulating layer, a magnetic-flux density amplitude, and a magnetic-flux density frequency were as described in Table 1. In Table 1, the width means a distance between an outer periphery and an inner periphery of the soft magnetic strip, and the length means a perimeter of a circle intermediate between the outer periphery and the inner periphery of the soft magnetic strip, that is, an average of an outer peripheral length and an inner periphery length. FIG. 12 illustrates the calculation result. In FIG. 12, “Proportion of Area of Direct Contact Region” means a proportion of an area of the direct contact region relative to the area of the interface.

TABLE 1

| Soft Magnetic Strip | Resistivity (Ω · m) | 1 × 10⁻⁷ |
|---|---|---|
| | Thickness (μm) | 25 |
| | Width (mm) | 12.2 |
| | Length (mm) | 132.57521 |
| | Outer Diameter (mm) | 54.4 |
| | Inner Diameter (mm) | 30 |
| Insulating Layer | Resistivity (Ω · m) | 1 × 10¹⁴ |
| | Thickness (μm) | 0.1 |

| | |
|---|---|
| Magnetic-Flux Density Amplitude (T) | 1 |
| Magnetic-Flux Density Frequency (Hz) | 400 |

### Example 2

Laminated cores having structures similar to those of Example 1 were manufactured, and eddy-current losses were measured at a magnetic-flux density similar to that of Example 1. FIG. 12 illustrates the measurement result.

The calculation result of Example 1 and the measurement result of Example 2 were matched well. The results of Examples 1 and 2 exhibited that the eddy-current loss was sufficiently reduced when the direct contact region has the area of 20% or less of the area of the interface.

### Example 3

Eddy-current losses of laminated cores including five laminated soft magnetic strips having circular ring shapes and insulating layers disposed between the soft magnetic strips adjacent to one another as illustrated in FIG. 5 and FIG. 6 were calculated using the magnetic circuit method.

In the laminated core of Example 3, a plurality of the insulating layers having circular ring shapes concentric with the soft magnetic strip were disposed in an interface between the soft magnetic strips adjacent to one another. Thus, a plurality of direct contact regions and a plurality of indirect contact regions having the circular ring shapes concentric with the interface were disposed in each interface. The soft magnetic strips adjacent to one another were in direct contact with one another in the direct contact regions, and the soft magnetic strips adjacent to one another were in indirect contact with one another via the insulating layers in the indirect contact regions. The total area of the plurality of direct contact regions in each interface was set to be from 0 to 100% of an area of the interface. Note that the number of insulating layers and an inner diameter and an outer diameter of each insulating layer were randomly set in each interface. That is, arrangements of the insulating layers in plan view in the laminating direction of the soft magnetic strips were different in all the interfaces. Values of resistivity, a thickness, a width, a length, and an outer diameter and an inner diameter of the soft magnetic strip, a resistivity and a thickness of the insulating layer, a magnetic-flux density amplitude, and a magnetic-flux density frequency were as described in Table 1. Since the calculation result well matched a measurement result of Example 4 described below, the illustration is omitted.

### Example 4

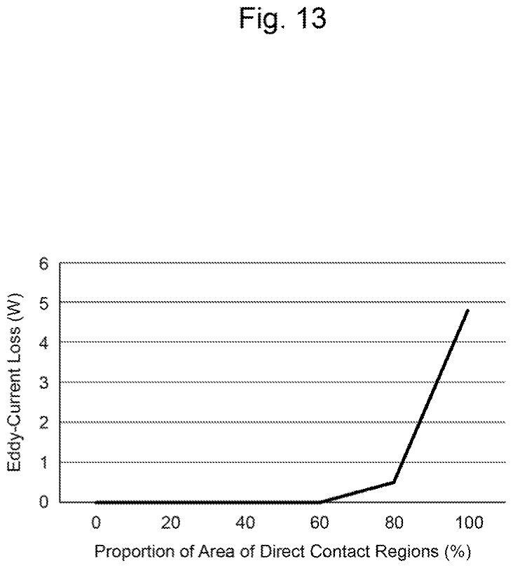

Laminated cores having structures similar to those of Example 3 were manufactured, and eddy-current losses were measured at a magnetic-flux density similar to that of Example 3. FIG. 13 illustrates the measurement result. In FIG. 13, “Proportion of Area of Direct Contact Regions” means a proportion of the total area of the plurality of direct contact regions relative to the area of the interface.

The results of Examples 3 and 4 exhibited that the eddy-current loss was sufficiently reduced when the direct contact regions have the area of 60% or less of the area of the interface. The total area of the indirect contact regions (that is, the total area of the insulating layers) required to reduce the eddy-current loss in the laminated core in which the plurality of direct contact regions were randomly disposed in each interface as in Examples 3 and 4 was smaller than that required to reduce the eddy-current loss of the laminated core in which a single direct contact region was disposed in each interface as in Examples 1 and 2. This result shows that by randomly disposing the plurality of direct contact regions in each interface, the eddy-current loss can be sufficiently reduced while the proportion of the insulating layers is reduced and a higher space factor is achieved.

### Example 5

Eddy-current losses of laminated cores including three laminated soft magnetic strips having a circular ring shape and insulating layers disposed between the soft magnetic strips adjacent to one another as illustrated in FIG. 7 and FIG. 8 were calculated using the magnetic circuit method.

The laminated core of Example 5 included two interfaces each of which was between the soft magnetic strips adjacent to one another. In each of the two interfaces, 10 pieces of circular ring-shaped insulating layers concentric with the soft magnetic strip were disposed. Thus, a plurality of direct contact regions and a plurality of indirect contact regions having the circular ring shapes concentric with the interface were disposed in each interface. The soft magnetic strips adjacent to one another were in direct contact with one another in the direct contact regions, and the soft magnetic strips adjacent to one another were in indirect contact with one another via the insulating layers in the indirect contact regions. Note that a width of each insulating layer was set to be 0.06 times of a width of the soft magnetic strip. In each interface, 10 pieces of the insulating layers were regularly arranged between an inner edge and an outer edge of the soft magnetic strip at a pitch 0.1 times of the width of the soft magnetic strip. In plan view in the laminating direction of the soft magnetic strips, phases of the insulating layers in the two interfaces were shifted from one another by 0 to 180°. The total area of the plurality of direct contact regions in each interface was 40% of the area of the interface. Values of resistivity, a thickness, a width, a length, and an outer diameter and an inner diameter of the soft magnetic strip, a resistivity and a thickness of the insulating layer, a magnetic-flux density amplitude, and a magnetic-flux density frequency were as described in Table 1. Since the calculation result well matched the measurement result of Example 6 described below, the illustration is omitted.

### Example 6

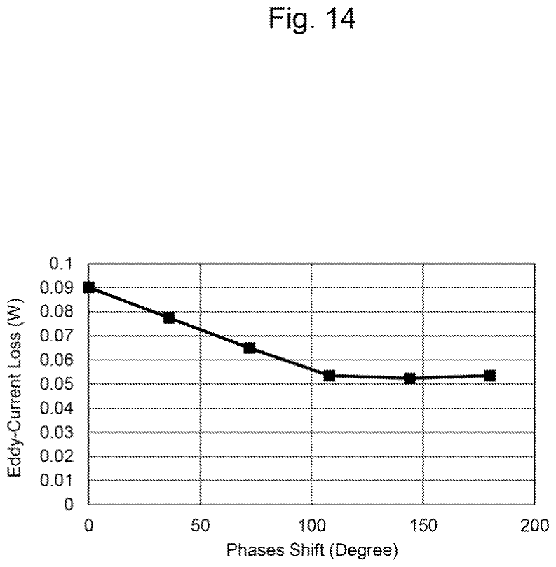

Laminated cores having structures similar to those of Example 5 were manufactured, and eddy-current losses were measured at a magnetic-flux density similar to that of Example 5. FIG. 14 illustrates the measurement result.

The eddy-current loss was sufficiently reduced at the phase shift from 108° to 180°. Note that, with the phase shift from 108° to 180°, the total area of regions included in direct contact regions in the one of the two interfaces, the regions overlapping with the direct contact regions of the other of the two interfaces in plan view in the laminating direction of the soft magnetic strips, was 0 to 10% of the area of the interface and 0 to 25% of the total area of the direct contact regions in each interface.

What is claimed is:

1. A laminated core comprising:
a plurality of laminated soft magnetic strips; and
at least one insulating layer arranged in part of each interface between the soft magnetic strips adjacent to one another,
wherein each of the interfaces between the soft magnetic strips adjacent to one another includes at least one direct contact region and at least one indirect contact region,
wherein the soft magnetic strips adjacent to one another are in direct contact with one another in the at least one direct contact region, and
wherein the soft magnetic strips adjacent to one another are in indirect contact with one another via the insulating layer in the at least one indirect contact region.

2. The laminated core according to claim 1,
wherein the at least one direct contact region in each of the interfaces includes a plurality of direct contact regions, and the direct contact regions have an total area of 60% or less of an area of the interface.

3. The laminated core according to claim 1,
wherein the at least one direct contact region in each of the interfaces includes a single direct contact region, and the direct contact region has an area of 20% or less of an area of the interface.

4. The laminated core according to claim 1,
wherein the plurality of soft magnetic strips include three or more soft magnetic strips,
wherein the laminated core includes two or more of the interfaces, each of the interfaces being between the soft magnetic strips adjacent to one another, and
wherein in plan view in a laminating direction of the soft magnetic strips, the at least one direct contact region in one of the interfaces adjacent to one another includes a region overlapping with the at least one direct contact region in another of the interfaces adjacent to one another, the region having an area from 0 to 10% of an area of the interface.
